(19) United States
(12) Patent Application Publication
(10) Pub. No.: US 2009/0165387 A1
(43) Pub. Date: Jul. 2, 2009

(54) Actuator for an Automobile

(76) Inventors: Michael Goldstein, Bat Yam (IL); Dan Raz, Haifa (IL)

Correspondence Address: THE NATH LAW GROUP, 112 South West Street, Alexandria, VA, 22314, US

(21) Appl. No.: 12/226,986

(22) PCT Filed: Apr. 18, 2007
(86) PCT No.: PCT/IL2007/000490

§ 371 Date: Dec. 4, 2008

(51) Int. Cl. E05F 15/10; E05F 15/00

(52) U.S. Cl. 49/340; 49/341

(57) ABSTRACT

An actuator adapted to actuate an element of an automobile, the actuator comprising at least one gear adapted to rotate eccentrically about a central axis during operation of the actuator.

### FIELD OF THE INVENTION

The present invention relates to electric window opening and closing mechanisms, particularly those adapted for use with a window which is adapted to pivotally open and close.

### BACKGROUND OF THE INVENTION

Pivotable windows are common in large cars, such minivans, as well as in smaller, two door cars. Such windows are typically opened and closed by a clasp mechanism comprising two members. A first member, in a manual arrangement, is hingedly attached to the frame of the car adjacent the window, and one or more secondary members are attached to the window and swingably articulated to the first member.

Several devices have been developed to replace the first member of the clasp mechanism with one which is rotated by an electric motor. These devices have the advantage that the window may be opened and closed remotely by activating the motor by a switch which may be located anywhere within the vehicle, such as in a location convenient to the driver and/or near passengers sitting by the window.

One example of such a device is disclosed in U.S. Pat. No. 5,203,113. Disclosed therein is a window opener composed of a motor retained in a casing, a damper for vibration isolation suitable interposed between the motor and the casing, a worm and a worm wheel which are concentrically connected to an output shaft of the motor, and pinion which is concentrically projected from the worm wheel, an output gear engaged with the pinion, a shaft projected from an upper surface of the output gear and a link mechanism for transforming a rotational force in one direction of the shaft into an opening force and transforming the rotational force in another direction of the shaft into a closing force of the window; being characterized in that the worm and worm wheel and the output gear are arranged in such a manner as to be superposed.

U.S. Pat. No. 5,680,728 discloses a direct drive power window actuator for remote opening and closing of a pivotal quarter window of an automotive vehicle comprising a reversible motor, a power transmitting gear device operatively connected with the motor at one end and with a rotary shaft at the other end for rotating the rotary shaft, and a linkage for converting the rotational torque of the rotary shaft into an opening-and-closing force for the window.

U.S. Pat. No. 6,195,940 discloses a vehicle window direct drive power actuator for pivoting a window outwardly of a vehicle body about an axis. The actuator comprises a reversible electric motor and a power transmitting gear train driven by the motor and including a rotational output gear. The rotational output gear includes stop circuit actuating member thereon for actuating a motor control circuit that controls energization of the reversible electric motor to thereby electrically control the open and closed positions of the window relative to the vehicle body. A window linkage assembly is mounted on the window in a manner to convert the rotational torque of the rotary output gear into an opening-and-closing force for the window. The linkage assembly converts the rotational torque of the rotary output gear in a one direction into a window opening force and a rotational torque in the opposite direction, caused by reversing the driving motor, into a window closing force.

U.S. Pat. No. 6,561,055 disclosed an actuator for a vent window of a motor vehicle wherein the drive mechanism interconnecting the output shaft of the motor and the pivot arm controlling the vent window comprises a first worm driven by the motor output shaft, a first worm wheel driven by the first worm, a second worm driven by the first worm wheel, and a second worm wheel driven by the second worm in driving the pivot arm. The first worm wheel is formed of a plastic material and the actuator further includes a coil spring mounted on the housing proximate the second worm wheel and operative to assist the second worm wheel in generating a sealing force sufficient to positively seal the vent window against a window seal of the motor vehicle.

### SUMMARY OF THE INVENTION

According to one aspect of the present invention, there is provided an actuator adapted to actuate an element of an automobile, the actuator comprising at least one gear adapted to rotate eccentrically about a central axis during operation of the actuator.

It will be appreciated that hereafter in the specification and claims, the term automobile is to be understood in its broadest sense, not being limited to passenger vehicles, but also including light trucks, tractor-trailers, etc.

The actuator may further comprise a compound gear having first and second stages, a fixed base, and a transmission element rotatably received therewithin. The base comprises a portion which constitutes a first internal annulus gear, and the transmission element comprises a portion which constitutes a second internal annulus gear. The base and the transmission element are adapted for co-disposition such that the portions are adjacent to one another and the internal annulus gears are coaxially disposed. The compound gear is mounted so that the first stage rotates eccentrically within the first annulus gear, and the second stage rotates eccentrically within the second annulus gear.

Each stage of the compound gear may be adapted to mesh with one of the internal annulus gears at a gear ratio different from the other.

The actuator may further comprise a motor. A worm may be mounted to a shaft of the motor.

The actuator may further comprise a gear, being different from the at least one gear, having an eccentrically mounted circular boss. The boss is adapted to provide the eccentric rotation of the at least one gear.

The gear having the eccentrically mounted circular boss may be a worm gear, which may be driven by a worm mounted to a shaft of a motor.

The element may constitute part of the exterior of the automobile, e.g., it may be a pivotable window, for example located on the roof or side of the vehicle.

According to another aspect of the present invention, there is provided an actuator adapted to pivotally move an element pivotally articulated to a frame. The actuator comprises a bracket arm and a motor having a motor shaft. The bracket arm rotates about an axis which is parallel to or coincident with the motor shaft.

The actuator comprises one or more gears, each rotatable about a respective axis, all of which are parallel to or coincident with the motor shaft. The gears constitute a gear train adapted to reduce the angular velocity of the bracket arm.

According to one particular embodiment, the actuator further comprises a compound gear comprising first and second gear stages, and a transmission shaft rotatably received within an immovable base. The transmission shaft and the base each comprise a portion which constitutes an internal annulus gear. The transmission shaft and the base are adapted to be co-disposed so that the internal annulus gears are coaxial and adjacent one another. The compound gear is mounted so as to rotate eccentrically to the internal annulus gears. Each stage of the compound gear is adapted to mesh with one of the internal annulus gears at a different gear ratio from the other.

The actuator is adapted to be mounted to the frame such that the motor shaft is generally parallel to the axis about which the element pivots. This provides the advantage that the actuator occupies a relatively small volume, and does not substantially extend perpendicularly away from the window. The element according to one application of the present invention may be a window of a motor vehicle.

According to a further aspect of the present invention, there is provided a motor vehicle having a window pivotally articulated to the vehicle frame, and being provided with an actuator according to the present invention.

### BRIEF DESCRIPTION OF THE DRAWINGS

In order to understand the invention and to see how it may be carried out in practice, an embodiment will now be described, by way of a non-limiting example only, with reference to the accompanying drawings, in which:

FIGS. 1A and 1B illustrate a first example of an actuator, with a cover removed, according to the present invention installed to a car window, with the window in open and closed positions, respectively;

FIG. 2A is a perspective view of the actuator illustrated in FIGS. 1A and 1B, with a cover thereof removed;

FIG. 2B is a cross sectional view of the actuator illustrated in FIGS. 1A and 1B, taken along line II-II in FIG. 2A;

FIG. 2C is an exploded view of the actuator illustrated in FIGS. 1A and 1B;

FIG. 3 is a perspective view of a base of the window actuator illustrated in FIGS. 1A and 1B;

FIG. 4 is a perspective view of a transmission shaft of the actuator illustrated in FIGS. 1A and 1B;

FIG. 5 is a perspective view of the transmission shaft illustrated in FIG. 4 received within the base illustrated in FIG. 3;

FIG. 6 is a perspective view of a spur gear of the actuator illustrated in FIGS. 1A and 1B;

FIG. 7 is a perspective view of a compound gear of the actuator illustrated in FIGS. 1A and 1B;

FIG. 8 is a perspective view of a bracket arm of the actuator illustrated in FIGS. 1A and 1B;

FIGS. 9A through 9H are schematic representations of sequential progress of the rotation of the spur gear illustrated in FIG. 6 about a support pin;

FIGS. 10A through 10H are schematic representations of sequential progress of the rotation of the compound gear illustrated in FIG. 7 within portions of the base and transmission shaft illustrated in FIGS. 3 and 4, respectively;

FIGS. 11A and 11B illustrate a second example of an actuator according to the present invention, with a cover removed, installed to a car window, with the window in open and closed positions, respectively;

FIG. 12A is a perspective view of the actuator illustrated in FIGS. 11A and 11B, with a cover thereof removed;

FIG. 12B is a cross sectional view of the actuator illustrated in FIGS. 11A and 11B, taken along line XII-XII in FIG. 12A;

FIG. 12C is an exploded view of the actuator illustrated in FIGS. 11A and 11B;

FIG. 13 is a perspective view of a base of the actuator illustrated in FIGS. 11A and 11B;

FIG. 14 is a perspective view of a transmission element of the actuator illustrated in FIGS. 11A and 11B;

FIG. 15 is a perspective view of the transmission element illustrated in FIG. 14 received within the base illustrated in FIG. 13;

FIG. 16 is a perspective view of a worm gear of the actuator illustrated in FIGS. 11A and 11B; and

FIG. 17 is a perspective view of a compound gear of the actuator illustrated in FIGS. 11A and 11B.

### DETAILED DESCRIPTION OF EXEMPLARY EMBODIMENTS

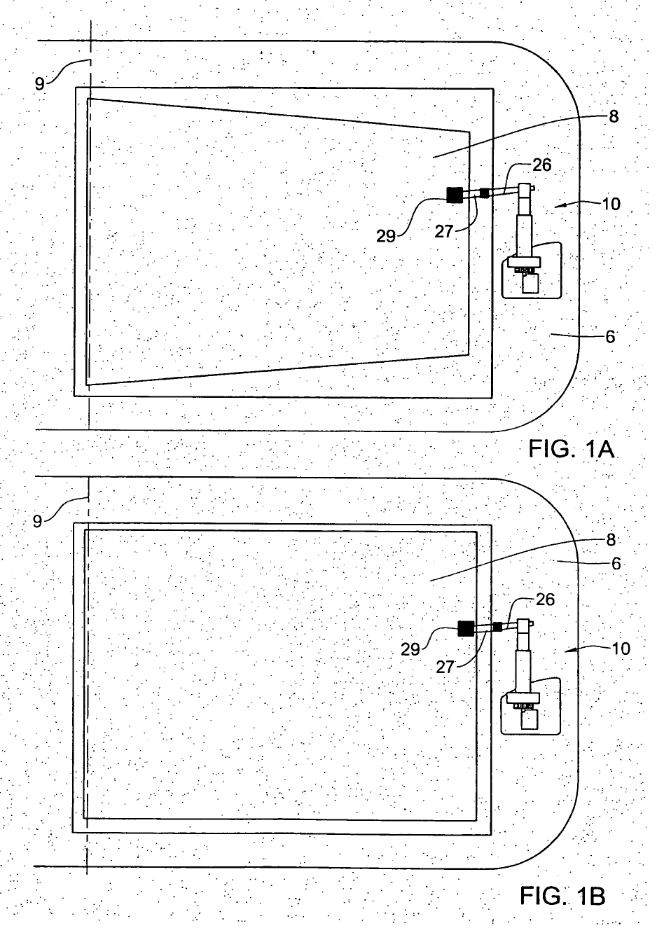

FIGS. 1A and 1B illustrate a first example of an actuator, generally designated 10, according to the present invention, installed on a frame portion 6 of a car, adjacent an element, such as a pivotable window 8, which may be a side or roof window, thereof. The window 8 is adapted to pivot open about an axis 9 which is on located on the edge of the window opposite the one adjacent the actuator 10.

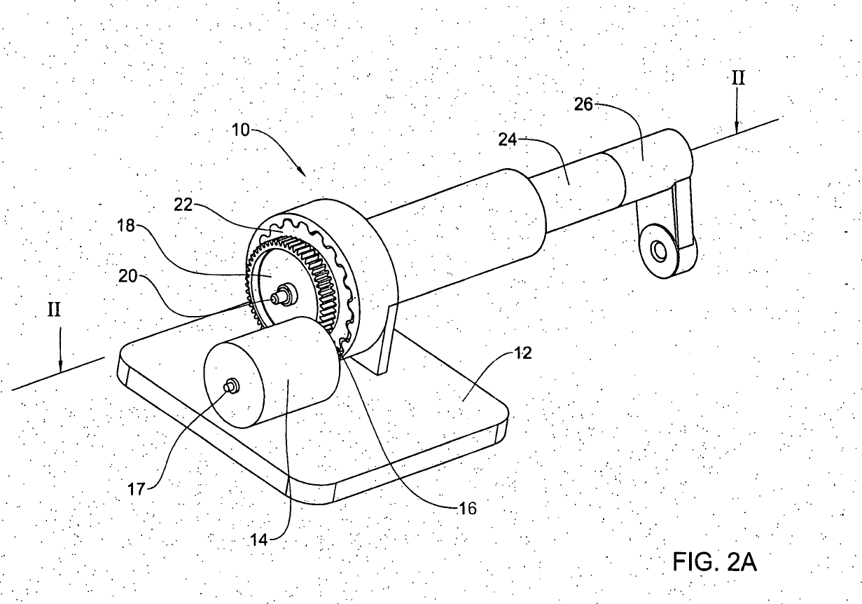

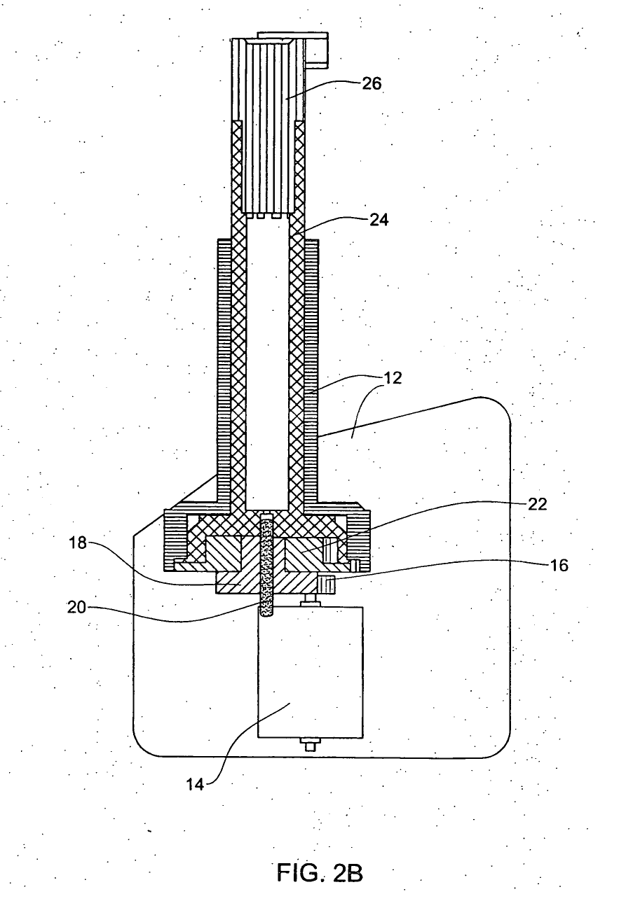

FIGS. 2A through 2C illustrate the actuator 10 in more detail. It comprises a base 12, an electric motor 14 with a pinion gear 16 mounted on a motor shaft 17 thereof, a transmission shaft 24, a spur gear 18 rotatable about a support pin 20 coaxially with the transmission shaft, a compound gear 22, and a bracket arm 26.

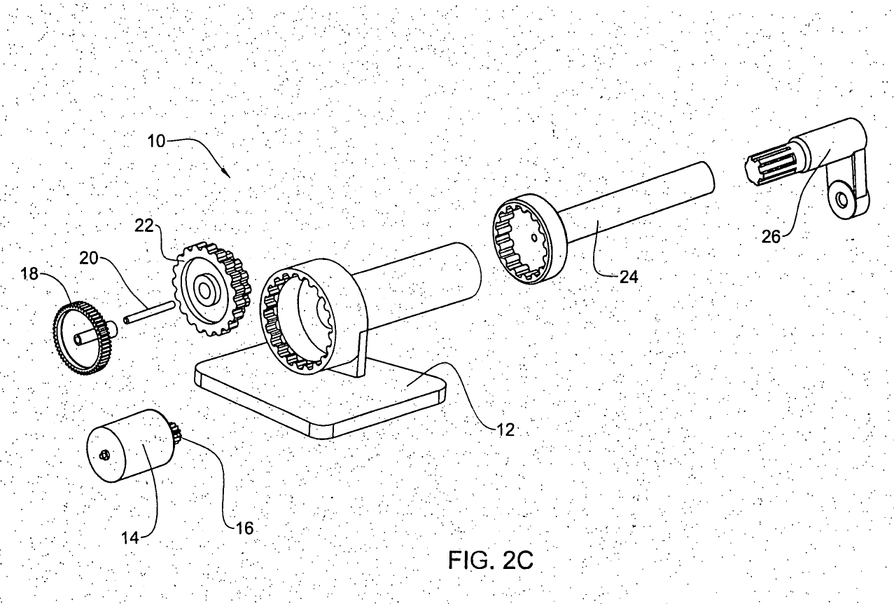

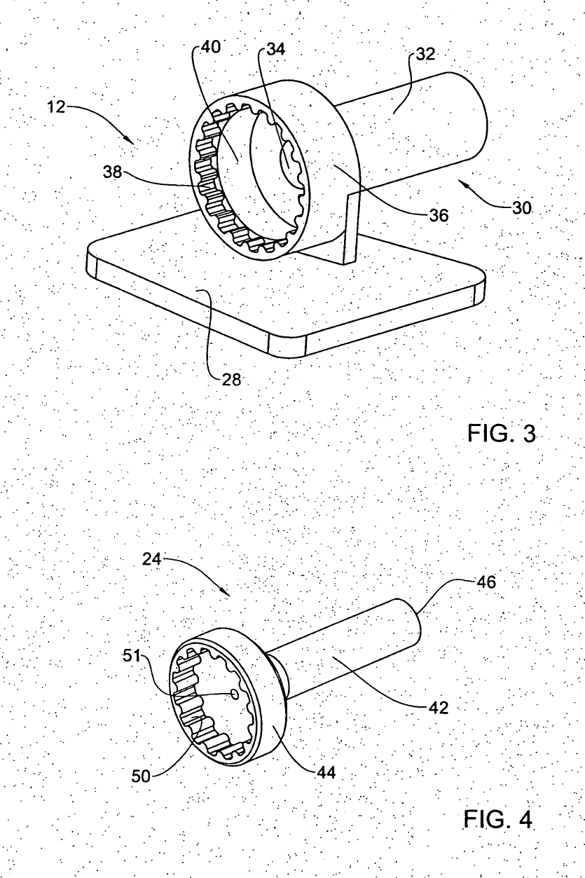

The base 12, as seen in FIG. 3, comprises a plate 28, which is adapted to be fastened to the frame 6 of a car, as seen in FIG. 1, and a shaft support portion, generally indicated at 30, affixed thereto. The shaft support portion 30 comprises a hollow base member 36 and a hollow sleeve 32. The interior surface of the base member 36 constitutes a first internal annulus gear 38 near an edge thereof, and a coaxial peripheral seat 40 located adjacent thereto. The motor 14 (as seen in FIG. 2A) is fixedly attached to the plate 28.

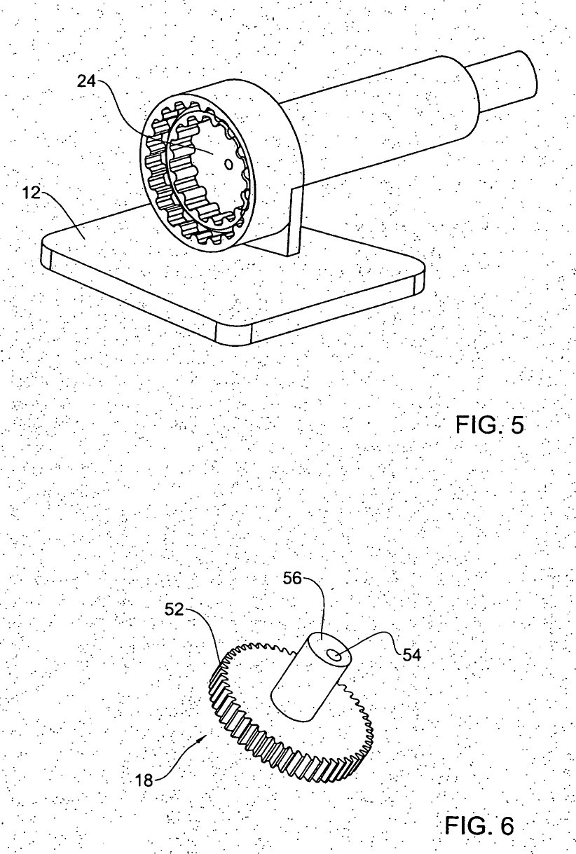

The transmission shaft 24, as seen in FIG. 4, comprises a shaft portion 42 and a flange 44. The shaft portion 42 is adapted, at a distal end 46 thereof, to receive the bracket arm 26 so that both elements rotate in tandem, as will be explained hereinafter with reference to FIG. 8. The flange 44 is formed internally so as to constitute a second internal annulus gear 50. It further comprises a coaxial centrally located bore 51, adapted for receiving the support pin 20. The shaft portion 42 and the flange 44 are sized so as to be snuggly received yet rotatable within the sleeve 32 and the seat 40, respectively, of the base 12. FIG. 5 illustrates how the shaft 24 is received within the base 12.

FIG. 6 illustrates the spur gear 18. It comprises teeth 52 adapted to mesh with the pinion gear 16, and a centrally located through-going aperture 54. The spur gear 18 further comprises a boss 56, which is located eccentrically to the gear.

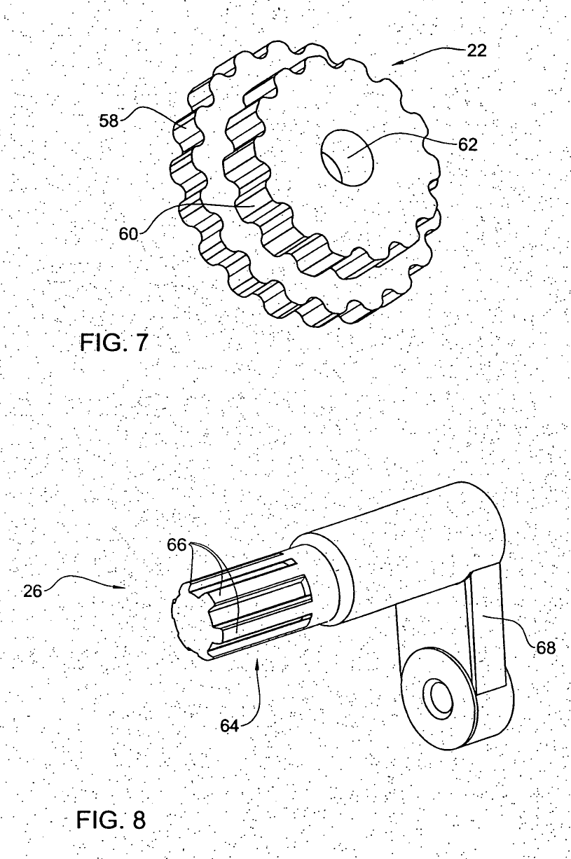

The compound gear 22, as illustrated in FIG. 7, comprises a first stage 58, which is adapted to mesh with the first internal annulus gear 38, and a second stage 60, adapted to mesh with the second internal annulus gear 50. In the embodiment shown, each stage 58, 60 comprises one fewer tooth than does the corresponding internal annulus gear. It should be noted that the difference in number of teeth between each stage of the compound gear and the corresponding internal annulus gear may be more than one, provided that the internal annulus gear comprises more teeth than the corresponding stage of the compound gear. The compound gear 22 further comprises a centrally located through-going aperture 62, sized to snuggly receive the boss 56 of the spur gear 18, but to still allow for slippage.

FIG. 8 illustrates the bracket arm 26. As previously mentioned, it is adapted to pivot the window open and closed upon its rotation. As illustrated in FIGS. 1A and 1B, the bracket arm constitutes a first member of a clasp mechanism, with a second member 27 being hingedly attached thereto at one end and to the a fixture 29 at the other end. The fixture is fixed to the window 8. When the window is in the open position, the clasp mechanism is substantially fully extended. In order to close the window, the bracket arm is rotated, causing the clasp mechanism to collapse.

The bracket arm 26 comprises a connector portion, generally indicated at 64, comprising a plurality of ridges 66, said ridges being shaped and located so as to cooperate with a correspondingly shaped portion of the transmission shaft 24 for being snuggly received therewithin.

It will be appreciated that while the present connector portion 64 is described herein as comprising ridges, any suitable arrangement, such as a slot and bar arrangement, may be used. The bracket arm 26 further comprises a joint portion 68 disposed at a right angle to the connector portion 64, adapted to be coupled to a standard window opening mechanism. While the bracket arm 26 illustrated in FIG. 8 is intended to be used as part of a standard window opening method, it will be appreciated that it may be constructed to directly connect to a window for opening and closing thereof.

The spur gear 18, the transmission shaft 24, and the shaft support portion of the base 12 are all mounted coaxially with the support pin 20. As best seen in FIG. 2B, the compound gear 22 is mounted eccentrically to the support pin 20.

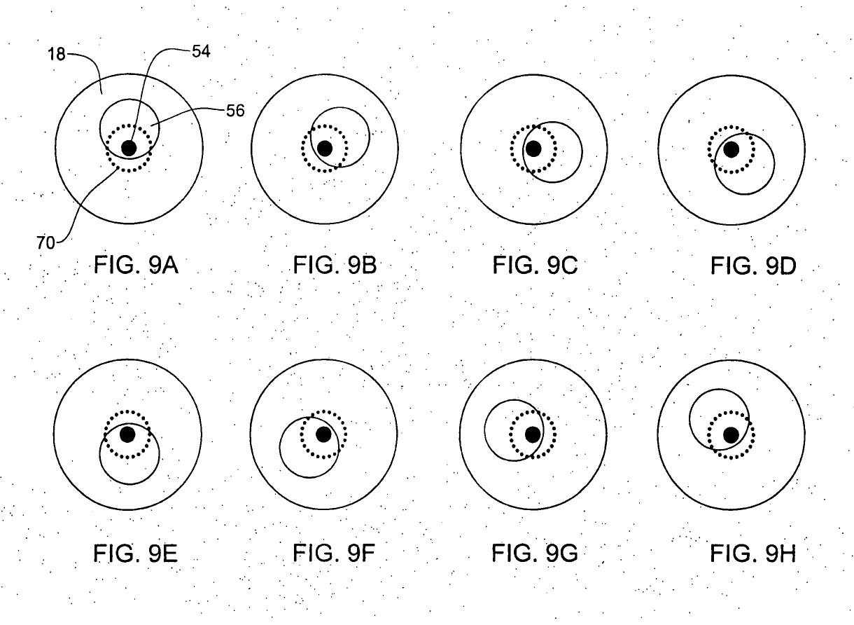

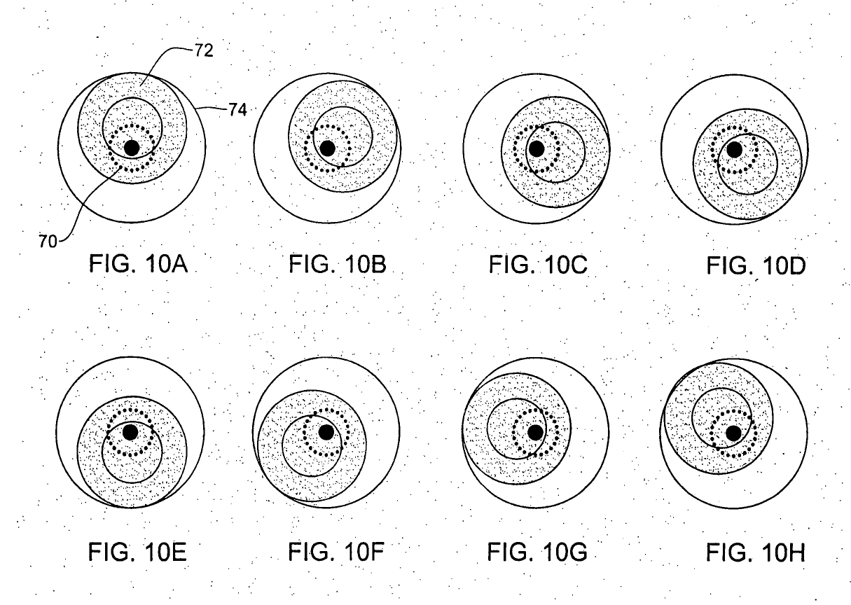

In operation, the motor 14 is activated, rotating the pinion gear 16, which drives the spur gear 18. The spur gear 18 is rotated about the support pin 20. As illustrated schematically in sequential FIGS. 9A through 9H, due to its eccentric location on the spur gear, the boss 56 is rotated about the aperture 54, with its center following the path of circle 70. The boss 56, received within aperture 62 of the compound gear 22, constitutes a shaft to drive the compound gear. The compound gear 22 is therefore rotated in an epicyclical manner about the inside peripheries of the internal annulus gear 38, 50, while rotating about its own center, as illustrated in sequential FIGS. 10A through 10H. (The grey circle 72 represents one of the stages 58, 60 of the compound gear 22, and the outer circle 74 represents the corresponding internal annulus gear 38, 50. Circle 70 is repeated in these figures for reference.) Since the compound gear rotates with a different gear ratio with respect to each internal annulus gear 38, 50, the angular speed of the compound gear with respect to the transmission shaft is different than the angular speed of the compound gear with respect to the base. Therefore, the transmission shaft rotates with respect to the base. Since the base is fixed, only a rotation of the transmission shaft 24 is observed. The rotation of the transmission shaft 24 gives rise to a rotation of the bracket arm 26, which opens or closes the window, depending on the direction of rotation.

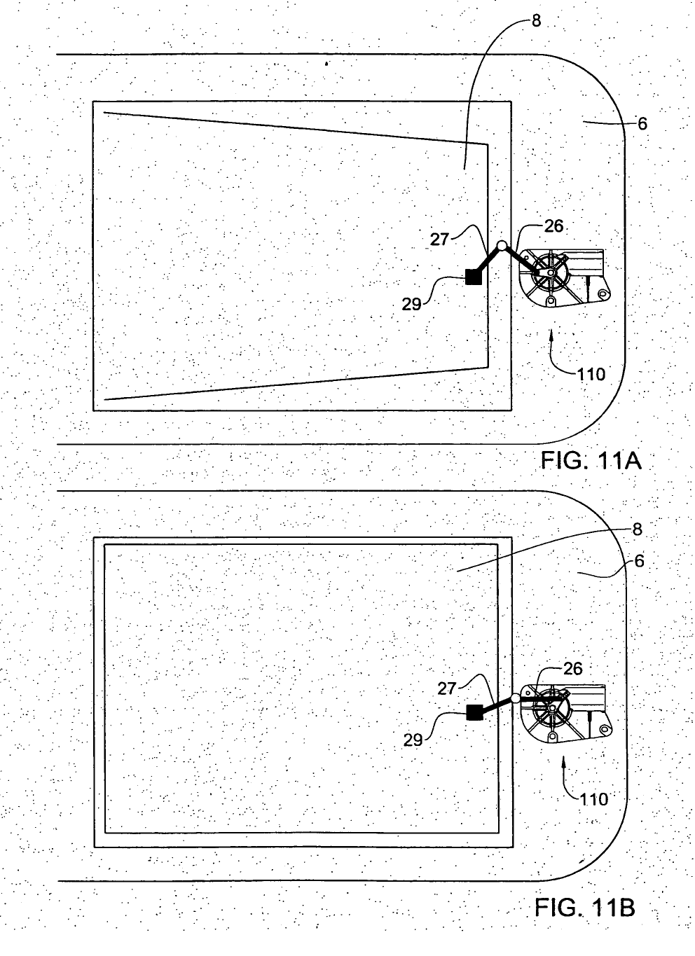

FIGS. 11A and 11B illustrate a second example of an actuator, generally designated 110, according to the present invention, installed on a frame portion 6 of a car, adjacent a pivotable window 8 thereof. The window 8 is adapted to pivot open about an axis 9 which is on located on the edge of the window opposite the one adjacent the actuator 10.

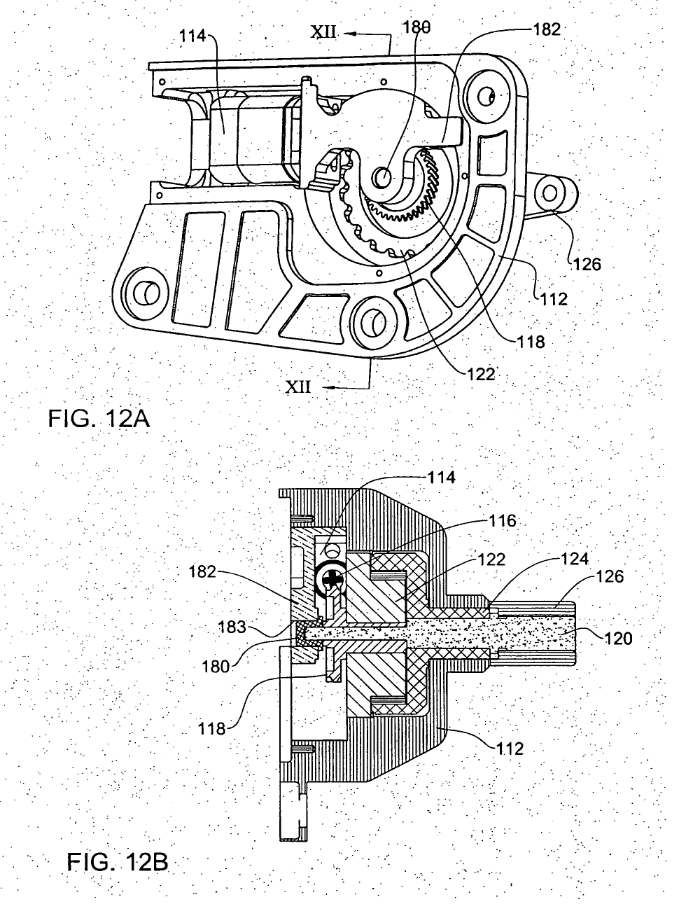

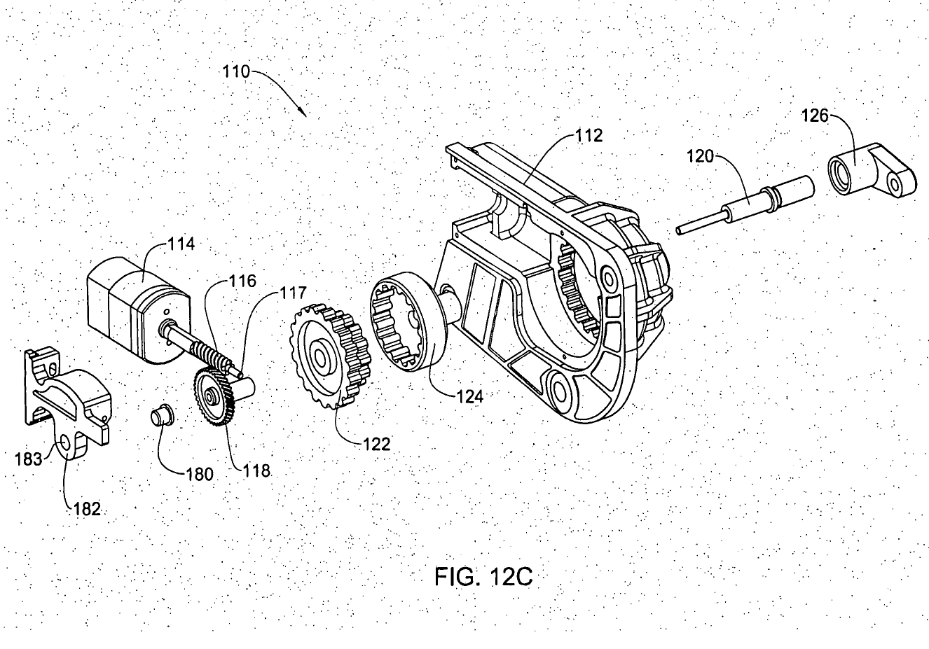

The actuator 110 is seen in more detail in FIGS. 12A through 12C. (Elements in the actuator 110 which have a functional counterpart in the actuator 10 described in reference to FIGS. 1 through 10 have been given corresponding reference numeral, shifted by 100.) The actuator 110 comprises a base 112, an electric motor 114 with a worm 116 mounted on a motor shaft 117 thereof, a transmission element 124, a worm gear 118 rotatable about a support pin 120 coaxially with the transmission element, a compound gear 122, and a bracket arm 126. In addition, the actuator 110 comprises a pin bearing 180 and a bracket 182 having an aperture 183 adapted for receiving the bearing therewithin and allowing for rotation thereof.

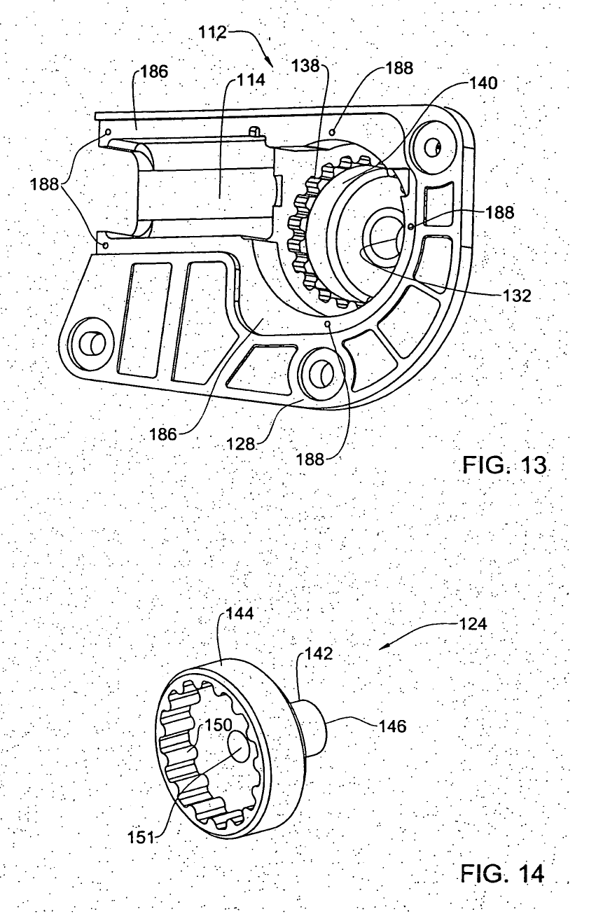

As illustrated in FIG. 13, the base 112 comprises a plate 128, which is adapted to be fastened to the frame 6 of a car, as seen in FIGS. 11A and 11B. It is further formed with a through-going aperture 132, adapted to receive therein a shaft portion of the transmission element 124, as will be explained below. An interior surface of the base 112 is formed as a first internal annulus gear 138, and an adjacent coaxial surface is formed as a peripheral seat 140. A portion 184 of the base 112 is formed so as to receive the motor 114. In addition, the plate 128 comprises a countersunk perimeter 186 surrounding the above features. Such a perimeter allows for securing a cover-plate (not illustrated in FIG. 13) to the base 112 in order to cover components placed therein, and allowing the plate to remain flush with the plate 128. Threaded bores 188 are provided to receive screws or bolts for attachment of the cover-plate.

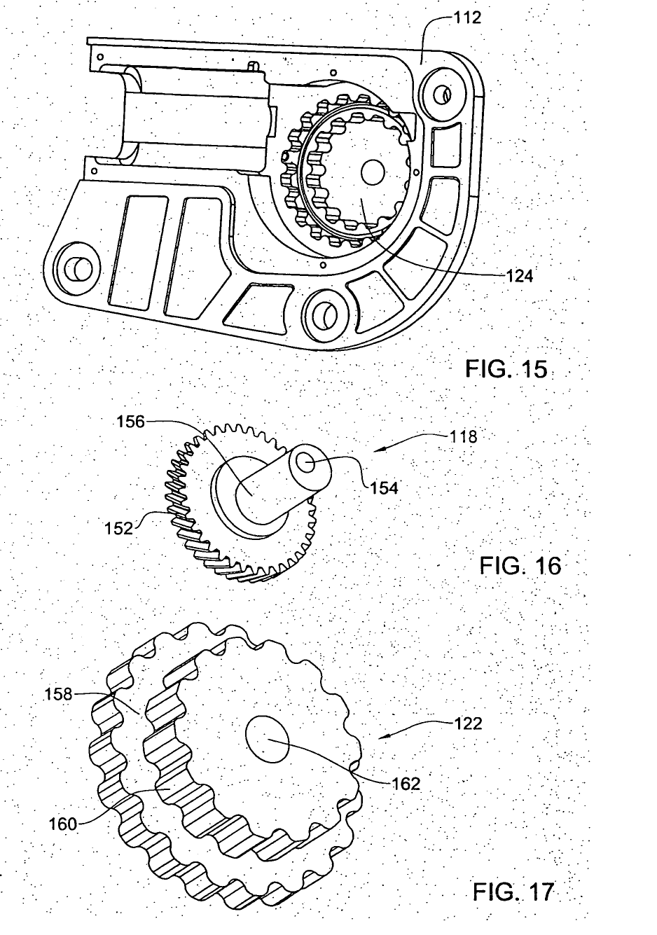

As illustrated in FIG. 14, the transmission element 124 comprises a shaft portion 142 and a flange 144. The shaft portion 142 is adapted, at a distal end 146 thereof, to receive the bracket arm 126 so that both elements rotate in tandem, in a similar manner as described with reference to FIG. 8. The flange 144 is formed internally so as to constitute a second internal annulus gear 150. It further comprises a coaxial centrally located bore 151, adapted for receiving the support pin 120. The shaft portion 142 and the flange 144 are sized so as to be snuggly received yet rotatable within the through-going aperture 132 and the seat 140, respectively, of the base 12. FIG. 15 illustrates how the transmission element 124 is received within the base 112.

As illustrated in FIG. 16, the worm gear 118 comprises helical teeth 152 adapted to mesh with the work shaft 116, and a centrally located through-going aperture 154. The spur gear 118 further comprises a boss 156, which is located eccentrically to the gear.

FIG. 17 illustrates the compound gear 122, comprises a first stage 158, which is adapted to mesh with the first internal annulus gear 138, and a second stage 160, adapted to mesh with the second internal annulus gear 150. In the embodiment shown, each stage 158, 160 comprises one fewer tooth than does the corresponding internal annulus gear. It should be noted that the difference in number of teeth between each stage of the compound gear and the corresponding internal annulus gear may be more than one, provided that the internal annulus gear comprises more teeth than the corresponding stage of the compound gear. The compound gear 122 further comprises a centrally located through-going aperture 162, sized to snuggly receive the boss 156 of the spur gear 118, but to still allow for slippage.

The bracket arm 182 is similar to the bracket arm 82 described above with respect to FIG. 8.

The worm gear 118 and the transmission element 124 are mounted coaxially with the through-going aperture 132 of the base. The support pin 120 is inserted coaxially through the worm gear 118 and the transmission element 124. As can be seen in FIG. 12B, the compound gear 122 is mounted eccentrically to the support pin 120. The bearing 180 is fitted onto the end of the support pin 120 which projects from the worm gear 118, as best illustrated in FIG. 12B. The bearing is placed within the aperture of the bracket 182. The bracket 182 is secured to the base 112. In this way, the support pin 120 may rotate substantially without wobbling.

The relative rotations of the worm gear 118, the compound gear 122, and the transmission element 124 are the same as the relative rotations of the spur gear 18, the compound gear 22, and the transmission shaft 24, respectively, as described above with reference to FIGS. 9A through 10H.

The overall gear ratio according to the first example of the internal annulus gear 38 of the base 12 to the internal annulus gear 50 of the transmission shaft 24 is dependent on the number of teeth in the two internal annulus gears and the number of teeth in each stage of the compound gear. As in known in the art (see, for instance, U.S. Pat. No. 6,743,137), the angular velocity of the transmission shaft 24 ωₜᵣₐₙₛ given by:

$${ω}_{trans} = {ω}_{s} \frac{i - j}{i \times j} \qquad ( 1 )$$

where ωₛ is the angular velocity of the spur gear, and i and j are given by:

$$\begin{matrix}i = \frac{{Z}_{cmp ( 1 )}}{{Z}_{base} - {Z}_{cmp ( 1 )}} \\ and & ( 2 ) \\ i = \frac{{Z}_{cmp ( 2 )}}{{Z}_{trans} - {Z}_{cmp ( 2 )}} & ( 3 )\end{matrix}$$

where Z_{cmp(1)} and Z_{cmp(2)} are the number of teeth of the first stage 58 and the second stage 60, respectively, of the compound gear 22, and Z_{base} and Zₜᵣₐₙₛ are the number of teeth of the first internal annulus gear 38 (associated with the base 12) and the second internal annulus gear 50 (associated with the transmission shaft 24), respectively.

Equation (1) can be rewritten to give an overall gear ration, expressed as a reduction between ωₛ and ωₜᵣₐₙₛ, as follows:

$$\frac{{ω}_{s}}{{ω}_{trans}} = \frac{i \times j}{i - j} \qquad ( 4 )$$

In the actuator of the present invention, the value for the overall gear ratio is summarized in Table 1.

TABLE 1

| Z_{cmp(1)} | Z_{cmp(2)} | Z_{base} | Zₜᵣₐₙₛ | i | j | ωₛ/ωₜᵣₐₙₛ |
|---|---|---|---|---|---|---|
| 19 | 14 | 20 | 15 | 19 | 14 | 53.2 |

As seen in Table 1, the angular velocity of the transmission shaft 24 is more than 50 times reduced from the angular velocity of the spur gear 18. This is in addition to the reduction of the motor speed due to the gear ratio between the pinion gear 16 and the spur gear 18.

The overall gear ratio according to the second example, as described with reference to FIGS. 1A through 17, can be found by substituting corresponding elements into the above discussion. As stated, elements according to the second example have been given corresponding reference numerals to their counterparts in the first example, shifted by 100.

It will be appreciated that while the specific embodiments described herein are directed toward a pivotable window of an automobile, the actuator according to the present invention may be used to actuate any part of an automobile, such as a windshield wiper, a seat or a portion thereof, etc.

Those skilled in the art to which this invention pertains will readily appreciate that numerous changes, variations and modifications can be made without departing from the scope of the invention mutatis mutandis.

1. An actuator adapted to actuate an element of an automobile, the actuator comprising at least one gear adapted to rotate eccentrically about a central axis during operation of the actuator.

2. An actuator according to claim 1, further comprising a compound gear having first and second stages, a fixed base, and a transmission element rotatably received therewithin, the base comprising a portion which constitutes a first internal annulus gear, and the transmission element comprising a portion which constitutes a second internal annulus gear, the base and the transmission element being adapted for co-disposition such that said portions are adjacent and said internal annulus gears are coaxially disposed, wherein the compound gear is mounted so that the first stage rotates eccentrically within the first annulus gear, and the second stage rotates eccentrically within the second annulus gear.

3. An actuator according to claim 2 each stage of the compound gear being adapted to mesh with one of the internal annulus gears at a gear ratio different from the other.

4. An actuator according to claim 1, further comprising a motor.

5. An actuator according to claim 4, comprising a worm mounted to a shaft of the motor.

6. An actuator according to claim 1, comprising a gear, being different from said at least one gear, having an eccentrically mounted circular boss, said boss adapted to provide the eccentric rotation of the at least one gear.

7. An actuator according to claim 6, wherein said gear having the eccentrically mounted circular boss is a worm gear.

8. An actuator according to claim 7, said gear being driven by a worm mounted to a shaft of a motor.

9. An actuator according to any one of the preceding claims, wherein said element constitutes part of the exterior of the automobile.

10. An actuator according to claim 9, wherein said element is a pivotable window, said actuator being adapted so as to open and close said window.

11. An actuator according to claim 10, wherein said window is located on the roof of the vehicle.

12. An actuator according to claim 10, wherein said window is located on the side of the vehicle.

13. An actuator according to any one of claims 1 through 8, wherein said element is selected from the group comprising windshield wipers and seats.

14. An actuator adapted to pivotally open and close an element pivotally articulated to a frame, the actuator comprising:
(a) a motor having a motor shaft; and
(b) a bracket arm,
wherein the bracket arm rotates about an axis which is parallel to or coincident with the motor shaft.

15. An actuator according to claim 14, further comprising a compound gear, and a transmission shaft rotatably received within an immovable base, the transmission shaft and the immovable base each comprising a portion which constitutes an internal annulus gear, the transmission shaft and base being adapted to be co-disposed so that said portions are adjacent, and said internal annulus gears are coaxially disposed, wherein the compound gear is mounted so to rotate-eccentrically to the internal annulus gears.

16. An actuator according to claim 15, wherein the compound gear comprises first and second stages, each stage being adapted to mesh with one of the internal annulus gears at a gear ratio different from the other.

17. An actuator according to claim 14, further comprising one or more gears, each of said gears being rotatable about an axis, all of said axes being parallel to or coincident with the axis of the motor shaft.

18. An actuator according to claim 14 adapted to be mounted to the frame such that the motor shaft is generally parallel to an axis of pivoting of the element.

19. An actuator according to claim 17, wherein said gears constitute a gear train adapted to reduce angular velocity of the bracket arm.

20. An actuator according to claim 19, wherein a pinion gear is mounted to the motor shaft, said pinion gear driving a spur gear.

21. An actuator according to claim 20, wherein the spur gear comprises an eccentrically mounted circular boss.

22. An actuator according to any one of claims 14 through 21, wherein the element is a window of a motor vehicle.

23. A motor vehicle having a window pivotally articulated to a frame, the vehicle comprising an actuator according to any one of claims 1 through 22.
